(19) United States
(12) Patent Application Publication
(10) Pub. No.: US 2021/0016656 A1
(43) Pub. Date: Jan. 21, 2021

(54) Valve Assembly for a Fuel Tank

(71) Applicant: Alfmeier Präzision SE, Treuchtlingen (DE)

(72) Inventors: Markus Stephan, Gnotzheim (DE); Werner Ruppert, Langenaltheim (DE); Sebastian Morgott, Weissenburg (DE); Jens Donat, Augsburg (DE)

(21) Appl. No.: 16/927,053

(22) Filed: Jul. 13, 2020

(30) Foreign Application Priority Data
Jul. 18, 2019 (DE) 10 2019 119 576.4

(51) Int. Cl. B60K 15/035; F16K 15/02; F16K 15/18

(52) U.S. Cl. CPC B60K 15/03519; F16K 15/186; F16K 15/025

(57) ABSTRACT

A valve assembly for a fuel tank includes a housing with a tank connection and a filter connection to respectively connect the valve assembly to the fuel tank and to an active carbon filter. The tank connection and the filter connection are or can be fluidically connected through a vent duct. A main vent valve with a valve element in the vent duct closes the vent duct in a closing position and opens it in a releasing position. A pilot valve to open the main vent valve is or can be fluidically connected to a pressure chamber of the main vent valve or to an overflow area. The overflow area fluidically connects or can fluidically connect the tank connection or a tank-side vent duct and the filter connection or a filter-side vent duct. Three check valves are also included.

### CROSS-REFERENCE TO RELATED APPLICATIONS

This application claims benefit to German Patent Application Number 10 2019 119 576.4, filed Jul. 18, 2019, which is incorporated in its entirety by reference herein.

### TECHNICAL FIELD

The disclosure relates to a valve assembly for a fuel tank of a vehicle. In particular, the disclosure relates to a valve assembly for the controlled and/or managed and/or regulated output or input of a fluid, preferably gasoline or air, or air enriched or saturated with fuel vapors containing hydrocarbons or hydrocarbons, from or into a fuel tank. In other words, the valve assembly can be used in connection with venting or ventilating the fuel tank. The subsequent use of the term venting should in each case also include the possibility of ventilating, i.e. a vent duct can also be used as ventilation duct or a vent valve can also be used as ventilation valve.

### BACKGROUND

In current vehicle tank systems, such a valve assembly must fulfill various tasks:

During refueling, fuel is replenished in the tank and excess pressure builds up in the tank. To lower this excess pressure and adjust the normal pressure once again a fuel tank is a lower-level pressure tank, the air enriched with hydrocarbons must be removed from the tank. In conventional tank systems in Europe, these hydrocarbon emissions are exclusively returned through a line connecting the tank to the filler neck during the refueling process and sucked out through the fuel nozzle. In conventional tank systems in the U.S., the gas quantity completely enriched with hydrocarbons must be guided through the activated carbon filter (hereinafter also “ACF”) during the refueling process in order to prevent hydrocarbon emissions from reaching the atmosphere. Since the filler neck also sucks in fresh air from the surroundings into the tank as well and this air can be enriched there with hydrocarbon, this would lead to a stronger loading of the ACF. For this reason, in tank systems in the U.S., a small part of the gases is also returned through a line connecting the tank to the filler neck (“recirculation”).

Another essential task of the valves or valve assemblies in a tank system consists of limiting the filling quantity of fuel in the fuel tank. The refueling process taking place at a fuel pump ends when the fuel rises in the filling pipe, thereby turning off the fuel pump. In order to allow the fuel to rise in the filling pipe, the venting pipe in the tank is closed by a float-controlled valve known as fill limit vent valve or FLVV when a certain filling level is reached. Subsequently, the pressure increases in the tank, as a result of which no more fuel can fill the tank.

Even during the normal operation of the vehicle, an excess pressure can be generated in the fuel tank, e.g. when the fuel heats up. Even the generation of a negative pressure, e.g. when the fuel cools off, is possible.

However, most valves or valve assemblies known so far and used for the above-mentioned functions can work only when there is excess pressure in the fuel tank, as a result of which the application field for the valve is substantially limited. Such a valve is known, for example, from US 2010/0051116 A1.

A valve system, which can work both under excess and negative pressure, is known from WO 2019/081709 A1. However, to fulfill this function, several pilot valves, one in each case for excess pressure and another one for negative pressure are needed, which results in higher costs and effort to control the valve system.

### SUMMARY

It is therefore the task of the disclosure to suggest a valve assembly that can be used both when there is excess pressure and negative pressure in the fuel tank.

The task is solved by a valve assembly for a fuel tank, especially a valve assembly, for the controlled and/or managed and/or regulated output or input of a fluid, preferably gas or air, or air enriched or saturated with hydrocarbons, from or into the fuel tank, having the characteristics of claim 1. The valve assembly encompasses a housing with a tank connection for connecting the valve assembly to the fuel tank and with a filter connection for connecting the valve assembly to an active carbon filter. Furthermore, the valve assembly encompasses at least one vent duct, wherein the tank connection and the filter connection are or can be fluidically connected through the vent duct. In the vent duct, a main vent valve having a valve element is arranged that closes in a closing position and opens in a release position. The tank connection and the filling pipe connection are likewise connected to one another through a vent duct.

Moreover, the valve assembly encompasses a pilot valve for opening the main vent valve, wherein the pilot valve is or can be fluidically connected to a pressure chamber, on the one hand, and to an overflow area, on the other hand, wherein the overflow area fluidically connects or can fluidically connect the tank connection or a tank-side vent duct and the filter connection or a filter-side vent duct.

The valve assembly additionally encompasses at least three check valves. A tank-pressure chamber-check valve is or can be fluidically connected to the tank connection or the tank-side vent duct, on the one hand, and to the pressure chamber of the main vent duct, on the other hand. An overflow area-tank-check valve is or can be fluidically connected to the overflow area, on the one hand, and to the tank connection or the tank-side vent duct, on the other hand. An overflow area-filter-check valve is or can be fluidically connected to the overflow area, on the one hand, and to the filter connection or the filter-side vent duct, on the other hand.

Here, the wording “tank-side” vent duct is understood to be the section of the vent duct between the fuel tank or the tank connection and the main vent valve. Accordingly, “filter-side” vent duct is understood to be here the section of the vent duct between the main vent valve and the filter connection or the activated charcoal filter. The term “filling pipe-side” vent duct used below describes the section of the vent duct between the tank connection or the tank-side vent duct and a filling pipe connection or the filling pipe.

The use of the term venting should in each case also include the possibility of ventilation, i.e. a vent duct can also be used as ventilation duct or a vent valve can also be used as ventilation valve.

The arrangement of the pilot valve according to the disclosure and of the at least three check valves as well as of the overflow area makes it possible to provide a valve or valve assembly able to implement all needed functions when there is excess pressure and negative pressure with only one pilot valve and only one main vent valve. By controlling the pilot valve, a deliberate opening of the main vent valve both under excess and negative pressure is possible, without needing another pilot valve or another control electronics assembly. Thus, the valve according to the disclosure allows a deliberate venting and ventilation of the fuel tank both under excess pressure and negative pressure.

According to a preferred embodiment, the valve assembly furthermore encompasses a pressure chamber-filter-check valve, which is or can be fluidically connected to the pressure chamber of the main vent valve, on the one hand, and to the filter connection or the filter-side vent duct, on the other hand. Thus, a total of four check valves are provided, thereby allowing a defined pressure to be adjusted inside the pressure chamber.

In additional advantageous designs, the housing can have a filling pipe connection for connecting the valve assembly to a filling pipe of the fuel tank.

Preferably, the valve element of the main vent valve is designed as valve membrane, wherein the valve membrane has a pressure side facing the pressure chamber of the main vent valve and a flow side facing the tank connection or the tank-side vent duct, the filter connection or filter-side vent duct and the filling pipe or filling pipe-side vent duct. In the closing position of the valve element, the flow side of the valve membrane closes the vent duct and opens the vent duct in the release position of the valve element. A pre-tensioning element arranged in the pressure chamber of the main vent valve exerts a force on the pressure side of the valve membrane. In particular, as a result of this, the valve element, specifically the valve membrane, is pre-tensioned in its closing position; for moving it to the release position, at least the force coming from the pre-tensioning element must be overcome, e.g. by the corresponding pressure conditions on the pressure side and the flow side of the valve membrane. The pre-tensioning element itself is, for example, guided by guiding means arranged on the valve membrane or the housing.

In a preferred embodiment of the valve assembly, it encompasses at least one bypass valve, which is or can be fluidically connected to the tank connection or the tank-side vent duct, on the one hand, and to the filter connection or the filter-side vent duct, on the other hand. Here, the at least one bypass valve can fluidically connect the tank connection or the tank-side vent duct and the filter connection or the filter-side vent duct directly or indirectly, e.g. through a space. By means of such bypass valves, it is possible to control the pressure in the fuel tank more precisely while the vehicle is being operated.

In another preferred embodiment, the valve assembly encompasses at least one recirculation valve, which is or can be fluidically connected to the tank connection or the tank-side vent duct, on the one hand, and to the filling pipe connection or the filling pipe-side vent duct, on the other hand. Such a recirculation valve allows the recirculation flow to be precisely controlled during refueling.

A further development of the disclosure provides the valve assembly with at least one excess pressure protection valve, especially a mechanical excess pressure protection valve, which is or can be fluidically connected to the tank connection or the tank-side vent duct, on the one hand, and to the filter connection or the filter-side vent duct, on the other hand. This ensures that the pressure in the fuel tank will not exceed a certain excess pressure limit, particularly when the valve system is not being operated.

A further advantageous embodiment provides the valve assembly with at least one negative pressure protection valve, which is or can be fluidically connected to the tank connection or the tank-side vent duct, on the one hand, and to the filter connection or the filter-side vent duct, on the other hand. This ensures that the pressure in the fuel tank will not exceed a certain negative pressure limit.

In a constructively advantageous design, the housing of the valve assembly forms an inner wall or several inner walls that separate the pressure chamber, the overflow area, the tank-side vent duct, the filter-side vent duct and/or the filling pipe-side vent duct from one another. The pilot valve, the tank-pressure chamber-check valve, the filter-pressure chamber-check valve, the overflow area-tank-check valve, the overflow area-filter-check valve, the at least one bypass valve, the at least one recirculation valve, the excess pressure protection valve and/or the negative pressure protection valve are in each case arranged in an opening formed in the inner wall or inner walls. The pilot valve, which is or can be fluidically connected to a pressure chamber of the main vent valve, on the one hand, and to an overflow area, on the other hand, is thus arranged in an opening of an inner wall separating the pressure chamber of the main vent valve and the overflow area from one another. This previous explanation applies analogously to the other valves mentioned above.

The pilot valve is a valve controlled by an actuator, preferably an SMA valve or an EAP valve or a solenoid valve or a pneumatic valve.

The basic functioning of SMA (Shape Memory Alloy) valves is known. Essentially, current is applied to the SMA element, which is a wire or band formed by a shape memory alloy, which transforms the structure from a martensitic structure to an austenitic structure above a transformation temperature, thereby warming it up and shortening it. In this case, the SMA element makes contact with the valve element in such a way that when it shortens, the SMA element exerts a force on the valve element thereby activating it, as a result of which a valve opening is released or closed.

The basic functioning of EAP (ElectroActive Polymer) valves is also known. EAP are polymers that change their shape when electrical voltage is applied. Examples mentioned here are dielectric elastomers (DEA valves or those with a Dielectric Elastomer Actuator). DEA consist, for example, of several polyurethane layers between which graphite layers are arranged as electrodes. If electrical voltage is applied on the electrodes so that the adjacent electrodes have different polarity, then the electrodes attract one another and due to the flexibility of the polyurethane layer (elastomer), they move towards each other. As a result of this, their wall thickness decreases and the surface area of the polyurethane layers increases. By arranging the actuator accordingly inside the valve, it is possible to cause the valve to open.

It is furthermore preferable for the at least one bypass valve to be an SMA valve or a DEA valve or a solenoid valve or a pneumatic valve.

Likewise, the at least one recirculation valve can preferably be an SMA valve or a DEA or a solenoid valve or a pneumatic valve.

### BRIEF DESCRIPTION OF THE DRAWINGS

The additional features and advantages of the disclosure will also be explained in a more detailed way below by describing embodiments and making reference to the enclosed drawings, which show in each case in a schematic diagram:

FIG. 1A shows a schematic diagram of a valve assembly according to a first embodiment with three check valves.

FIG. 1B shows a schematic diagram of a valve assembly according to a second embodiment with four check valves.

FIG. 2 shows a schematic diagram of a valve assembly according to a third embodiment.

FIG. 3 shows a schematic diagram of a valve assembly according to a fourth embodiment.

FIG. 4 shows a schematic diagram of a valve assembly according to a fifth embodiment.

FIG. 5 shows a perspective view of the valve assembly according to FIG. 2.

FIG. 6 shows a bottom view of the valve assembly according to FIG. 2 without housing bottom.

FIG. 7 shows a top view of the valve assembly according to FIG. 2 without housing lid.

FIG. 8 shows a perspective view of the valve assembly according to FIG. 2 without housing lid.

FIG. 9 shows a sectional view of the valve assembly according to FIG. 2 along the line A-A of FIG. 5.

### DETAILED DESCRIPTION

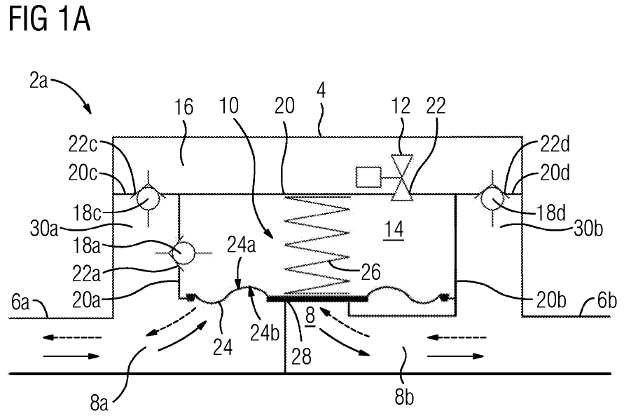

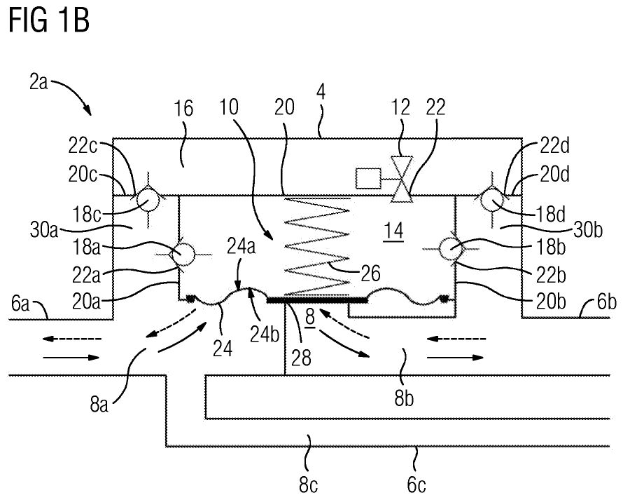

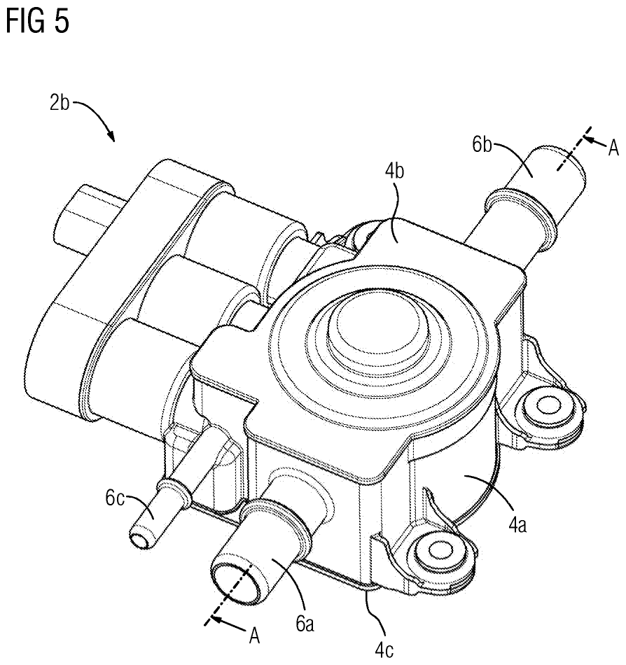

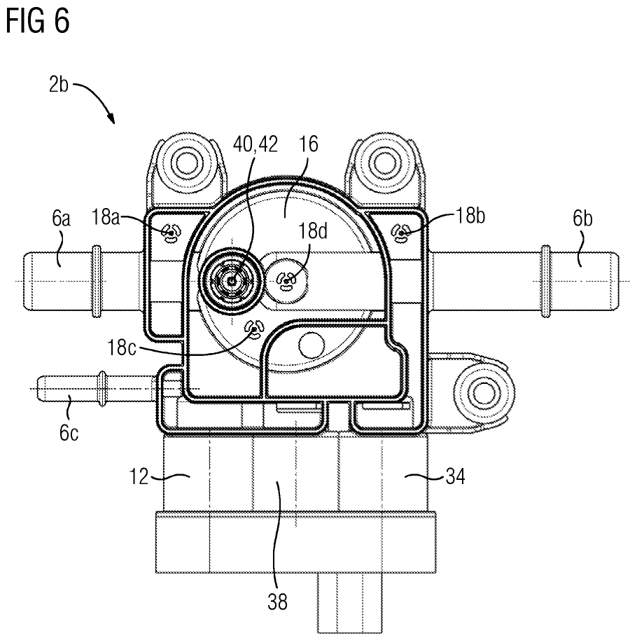

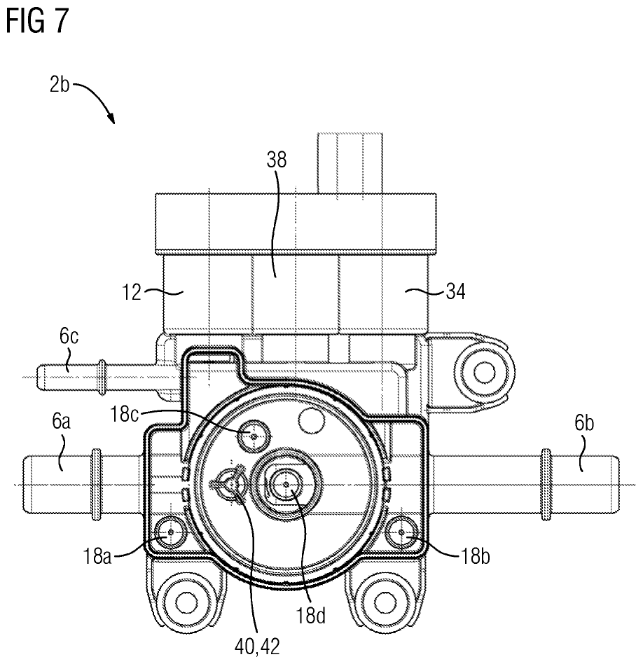

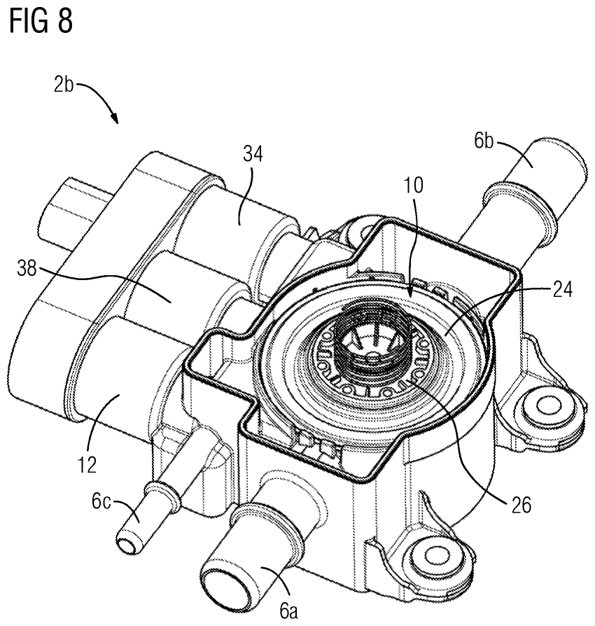

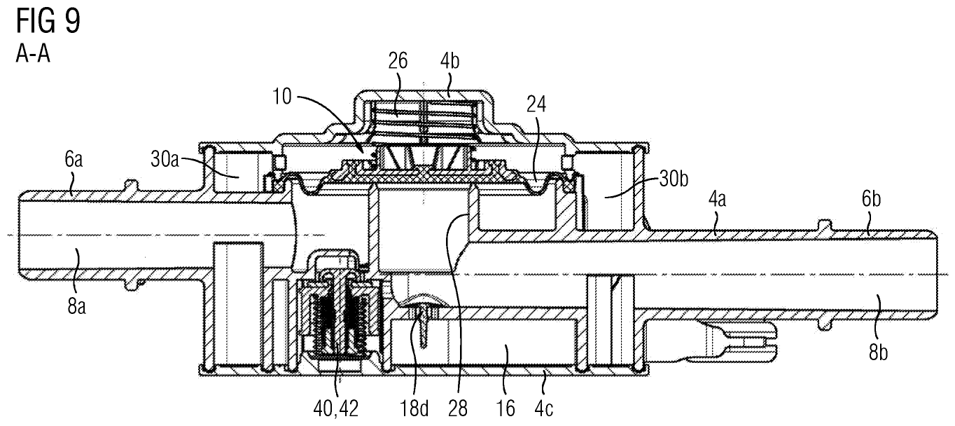

By means of FIG. 1A to FIG. 4, which in each case show a schematic view of a valve assembly, the basic structure or functioning should first of all be explained. Components that correspond to one another have been given the same reference signs. FIG. 5 to FIG. 9 show several views of a valve assembly according to an embodiment.

FIG. 1A and FIG. 1B show in each case a schematic view of a valve assembly 2a for the controlled and/or managed and/or regulated output or input of a fluid, preferably gas or air or air enriched or saturated with hydrocarbons coming out of or into the fuel tank according to a first embodiment. The valve assembly 2a encompasses a housing 4. The housing 4 has a tank connection 6a to connect the valve assembly 2a to the fuel tank (not shown). Furthermore, the valve system 2 has a filter connection 6b to connect the valve assembly 2a to an active carbon filter (not shown). Moreover, the valve system 2 can include a filling pipe connection 6c to connect the valve assembly 2a to a filling pipe (not shown), as shown exemplarily for the embodiment according to FIG. 1B. The valve assembly 2a can be connected to the fuel tank, the active carbon filter and the filling pipe through vent lines (not shown) or in each case directly without a vent line. The housing 4 can include an intermediate housing 4a, which forms the tank connection 6a, the filter connection 6b and possibly the filling pipe connection 6c, which in the assembled state can be closed on the upper side by a housing lid 4b, on the lower side by a housing bottom 4c, so that it is pneumatically sealed towards the surroundings (FIG. 5).

In the embodiment shown, the tank connection 6a and the filter connection 6b are or can be fluidically connected to one another through a vent duct 8, which encompasses a tank-side vent duct 8a and a filter-side vent duct 8b. A main vent valve 10, which closes the vent duct 8 in a closing position and opens it in a releasing position, has been arranged in the vent duct 8.

The valve assembly 2a additionally encompasses a pilot valve 12 for opening the main vent valve 10, wherein the pilot valve 12 is or can be fluidically connected to a pressure chamber 14 of the main vent valve 10, on the one hand, and to an overflow area 16, on the other hand. To achieve this, an inner wall 20 having an opening 22 in which the pilot valve has been arranged, is formed in the housing 4. In the embodiment shown, the overflow area 16 fluidically connects the tank connection 6a or a tank-side vent duct 8a and the filter connection 6b or a filter-side vent duct 8b to one another. In this case, the pilot valve 12 is an open/close valve with an actuator, exemplarily an SMA valve.

In the embodiment according to FIG. 1A, the valve assembly 2a encompasses three check valves, arranged according to the disclosure as described below.

An inner wall 20a, which has an opening 22a through which the tank connection 6a or the tank-side vent duct 8a is fluidically connected to the pressure chamber 14 of the main vent valve 10, is formed in the housing 4. A tank-pressure chamber-check valve 18a has been arranged in this opening 22a and thus if fluidically connected to the tank connection 6a or the tank-side vent duct 8a, on the one hand, and to the pressure chamber 14 of the main vent valve 10, on the other hand. Here, the opening 22a leads initially into a tank-side fluid duct or fluid area 30a, which in turn leads into the tank-side vent duct 8a.

In addition, an inner wall 20c that has an opening 22c through which the overflow area 16 is fluidically connected to the tank connection 6a or the tank-side vent duct 8a, is formed in the housing 4. An overflow area-tank-check valve 18c is arranged in this opening 22c and is thus fluidically connected to the overflow area 16, on the one hand, and to the tank connection 6a or the tank-side vent duct 8a, on the other hand. Here, the opening 22c leads initially into the tank-side fluid duct or fluid area 30a, which in turn leads into the tank-side vent duct 8a.

Moreover, an inner wall 20d having an opening 22d through which the overflow area 16 is fluidically connected here to the filter connection 6b or the filter-side vent duct 8b, is formed in the housing 4. An overflow area-filter-check valve 18d is arranged in this opening 22d and is thus fluidically connected to the overflow area 16, on the one hand, and to the filter connection 6b or the filter-side vent duct 8b, on the other hand. Here, the opening 22d leads initially into the filter-side fluid duct or fluid area 30b, which in turn leads into the filter-side vent duct 8b.

In the embodiment according to FIG. 1B, the valve assembly 2a encompasses an additional one and thus a total of four check valves. To this end, an inner wall 20b having an opening 22b through which the pressure chamber 14 of the main vent valve 10 is fluidically connected here to the filter connection 6b or the filter-side vent duct 8b, has been additionally formed in the housing 4. A filter-pressure chamber-check valve 18b is arranged in this opening 22b and is thus fluidically connected to the pressure chamber 14 of the main vent valve 10, on the one hand, and to the filter connection 6b or the filter-side vent duct 8b, on the other hand. Here, the opening 22b leads initially into a filter-side fluid duct or fluid area 30b, which in turn leads into the filter-side vent duct 8b.

To open and close the vent duct 8, the main vent valve 10 encompasses a valve element, circularly formed here as valve membrane 24. The valve membrane 24 has a pressure side 24a facing the pressure chamber 14 of the main vent valve 10 and a flow side 24b facing the filter connection 6b or the filter-side vent duct 8b. The flow side 24b of the valve membrane 24 closes the vent duct 8 in the closing position and opens it in the releasing position. A pre-tensioning element 26 arranged in the pressure chamber 14 of the main vent valve 10 exerts a force on the pressure side 24a of the valve membrane 24. The main vent valve 10 includes a valve membrane 24, here formed as a circle, as valve element. In an edge area, the valve membrane 24 has a circumferential U-shaped section that engages in a likewise circular U-shaped sealing seat formed from the housing 4 of the valve assembly 2a. A ring-shaped outer partial area of the flow side 24b abuts the tank-side vent duct 8a an, an inner partial area of the flow side 24b abuts the filter-side vent duct 8b.

The basic functioning of the main vent valve 10 will be explained in more detail below. When the fuel tank is being refueled, volume flows exceeding 40 L/min are expected, but the pressure in the fuel tank must be maintained at a low level so the fuel in the filling pipe that is flowing in does not rise prematurely and leads to the turning off of the fuel pump. This is achieved here by the main vent valve 10 designed as pre-controlled membrane valve. When the pressure increases in the fuel tank, i.e. excess pressure is generated there compared to the atmospheric pressure, the fluid (gas) flows out of the fuel tank, if necessary through a vent line, through the tank connection 6a into the vent duct 8, to be more precise to the tank-side vent duct 8a. The valve membrane 24 is closed, i.e. the fluid cannot keep flowing towards the filter connection 6b or to the active carbon filter. The fluid flows into the pressure chamber 14 of the main vent valve 10 through the opening 22a and the open tank-pressure chamber-check valve 18a. If a filter-pressure chamber-check valve 18b is provided (FIG. 1B), it is closed meanwhile, just as the pilot valve 12. Therefore, an excess pressure compared to the atmospheric pressure also builds up in the pressure chamber 14. Thus, the valve membrane 24 is pressed against an opening 28 of the filter-side main vent duct 8b and the valve element is thus closed in its closing position and therewith the main vent valve 10. No fluid can flow from the fuel tank through the vent duct 8 to the filter connection 6b and into the active carbon filter.

Excess pressure in the fuel tank can also be generated when the fuel tank is closed, for example by warming.

So fluid can flow from the fuel tank through the vent duct 8 into the active carbon filter, thereby able to reduce the excess pressure in the fuel tank, the main vent valve 10 must be opened. To do this, the pressure in the pressure chamber 14 and with it, on the pressure side 24a of the valve membrane 24 must be reduced to the extent that the valve membrane 24 lifts from the opening 28 of the filter-side vent duct 8b owing to the fluid pressure acting on its flow side 24b in the area of the tank-side vent duct 8a, thereby moving the valve element to its release position. As a result of this, the main vent valve 10 opens and releases the vent duct 8. This pressure reduction in the pressure chamber 14 takes place by the opening of the pilot valve 12 so fluid can flow out of the pressure chamber 14 towards the active carbon filter. Since the tank-pressure chamber-check valve 18a remains open, fluid keeps flowing from the fuel tank to the pressure chamber 14, but this subsequently flowing volume flow of the fluid is considerably smaller than the volume flow flowing out through the pilot valve 12, the overflow area 16, the overflow area-filter-check valve 18d, the filter-side fluid duct 30b and the filter-side vent duct 8b towards the active carbon filter because the flow diameter of the first opening 22a with the tank-pressure chamber-check valve 18a is considerably smaller than the flow diameter of the opened pilot valve 12. The fluid in the overflow area 16 can initially collect and flow from there through the overflow area-filter-check valve 18d to the filter-side vent duct 8b. To prevent a limitation of the pilot valve 12 by the overflow area-filter-check valve 18d through which the fluid is discharged from the overflow area 16, the flow diameter of the fourth opening 22d is larger than the flow diameter of the first opening 22a. In this way, the pressure in the pressure chamber 14 is reduced by the opening of the pilot valve 12, the main vent valve 10 opens and the vent duct 8 is released for the fluid to flow from the fuel tank to the active carbon filter and thus for reducing the pressure in the fuel tank. The fluid can therefore flow from the tank-side vent duct 8a through the main vent valve 10 into the filter-side vent duct 8b, as indicated in FIG. 1A and FIG. 1B by solid-line arrows.

In case of negative pressure in the fuel tank, which can occur due to cooling, for example, the pressure compensation can likewise be controlled through the main vent valve 10. If the pressure in the fuel tank falls, i.e. a negative pressure occurs there compared to the atmospheric pressure, fluid (gas or air) flows through the active carbon filter, possibly a vent line, the filter connection 6b into the vent duct 8, more precisely the filter-side vent duct 8b. The valve membrane 24 is closed, which means that the fluid cannot keep flowing towards the fuel tank. If a filter-pressure chamber-check valve 18b is present (FIG. 1B), the fluid flows through the filter-side fluid duct 30b, the second opening 22b and the open filter-pressure chamber-check valve 18b into the pressure chamber 14 of the main vent valve 10. The tank-pressure chamber-check valve 18a is closed, just as the pilot valve 12. Therefore, atmospheric pressure essentially prevails in the pressure chamber 14 and thereby a higher pressure than in the tank-side vent duct 8a and thus on the flow side 24b area of the valve membrane 24 that abuts the tank-side vent duct 8a. Hence, the valve membrane 24 is pressed against the opening 28 of the filter-side main vent duct 8b, the valve element is consequently in its closing position and therefore the main vent valve 10 is closed. No fluid can flow from the active carbon filter through the vent duct 10 into the fuel tank. The overflow area-filter-check valve 18d prevents a pressure compensation with the surroundings.

If no filter-pressure chamber-check valve 18b is present (FIG. 1A), no fluid flows into the pressure chamber 14, so that the previously trapped fluid volume and the existing pressure conditions remain unchanged inside the pressure chamber 14.

So fluid can flow from the active carbon filter through the vent duct 10 into the fuel tank and thus the negative pressure in the fuel tank can be reduced, the main vent valve 10 must be opened. To do this, the pressure in the pressure chamber 14 and with it, the pressure side 24a of the valve membrane 24 must be reduced to such an extent that the valve membrane 24 lifts from the opening 28 of the filter-side vent duct 8b owing to the fluid pressure (essentially atmospheric pressure) acting on its flow side 24b in the area of the filter-side vent duct 8b, the valve element therefore moves to its release position and as a result of that the main vent valve 10 opens and releases the vent duct 8. The pressure in the pressure chamber 14 is reduced, in turn, by opening the pilot valve 12. Consequently, fluid can flow from the pressure chamber through the pilot valve 12, the overflow area 16 and the overflow area-tank-check valve 18c into the fuel tank (in which negative pressure prevails). Since the filter-pressure chamber-check valve 18b if present is still open, fluid keeps flowing from the active carbon filter into the pressure chamber 14, but this subsequent volume flow of the fluid is considerably smaller than the volume flow flowing out towards the fuel tank because the flow diameter of the opening 22b with the filter-pressure chamber-check valve 18b is substantially smaller than the flow diameter of the opened pilot valve 12. In order to prevent a limitation of the pilot valve 12 by the overflow area-tank-check valve 18c through which the fluid is discharged from the overflow area 16, the flow diameter of the third opening 22c is larger than the flow diameter of the second opening 22b. In this way, the pressure in the pressure chamber 14 is reduced by opening the pilot valve 12, the main vent valve 10 opens and the vent duct 8 is released for the fluid to flow from the active carbon filter to the fuel tank and hence for reducing the pressure in the fuel tank. The fluid can thus flow from the filter-side vent duct 8b through the main vent valve 10 into the tank-side vent duct 8a, as indicated by dashed arrows in FIG. 1A and FIG. 1B.

The following embodiments show valve assemblies, in each case with four valves 18a to 18d, and a housing encompassing a filling pipe connection 6c and a filling pipe-side vent duct 8c. It goes without saying that every one of the embodiments shown below can also be designed with only three check valves and/or without filling pipe connection 6c or filling pipe-side vent duct 8c.

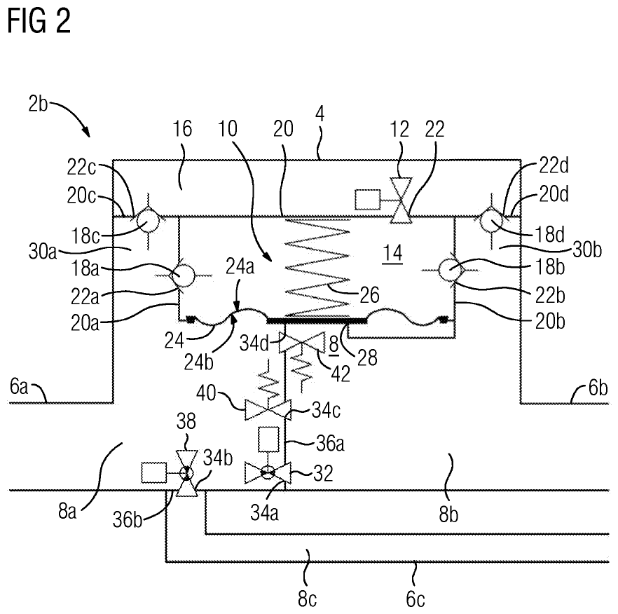

FIG. 2 shows a schematic view of a valve assembly 2b according to a third embodiment. FIGS. 5 to 9 merely show exemplarily a specific design of the valve assembly 2b. Thus, the components also described above for the valve assembly 2a (and the valve assemblies 2c, 2d described below) coinciding with valve assembly 2b therefore correspond those shown in FIGS. 5 to 9. Therefore, only the differences with regard to the valve assembly 2a will be described below; apart from that, reference is made to the explanations given above for FIGS. 1A, 1B with regard to both design and function. The valve assembly 2b encompasses one bypass valve 32, which is fluidically connected to the tank connection 6a or the tank-side vent duct 8a, on the one hand, and to the filter connection 6b or the filter-side vent duct 8b, on the other hand. The bypass valve 32 designed here as control valve with actuator, for example as SMA valve, allows a more precise control of the pressure in the fuel tank while the vehicle is being operated. The bypass valve 32 is arranged in an opening 34a of an inner wall 36a of the housing 4 separating the tank-side vent duct 8a from the filter-side vent duct 8b.

The valve assembly 2b encompasses furthermore a recirculation valve 38, which is fluidically connected to the tank connection 6a or the tank-side vent duct 8a, on the one hand, and to filling pipe connection 6c or the filling pipe-side vent duct 8c, on the other hand. The recirculation valve 38 is designed here as control valve with actuator, for example as EAP valve, and allows a precise regulation of the recirculation flow during refueling. The recirculation valve 38 is arranged in an opening 34b of an inner wall 36b of the housing 4 separating the tank-side vent duct 8a from the filling pipe-side vent duct 8c.

Additional openings 34c, 34d, in which an excess pressure protection valve 40 and a negative pressure protection valve 42, are arranged in the inner wall 36a and in each case fluidically connect the tank connection 6a or the tank-side vent duct 8a to the filter connection 6b or the filter-side vent duct 8b. The excess pressure protection valve 40 and the negative pressure protection valve 42 are in each case designed as a mechanical valve.

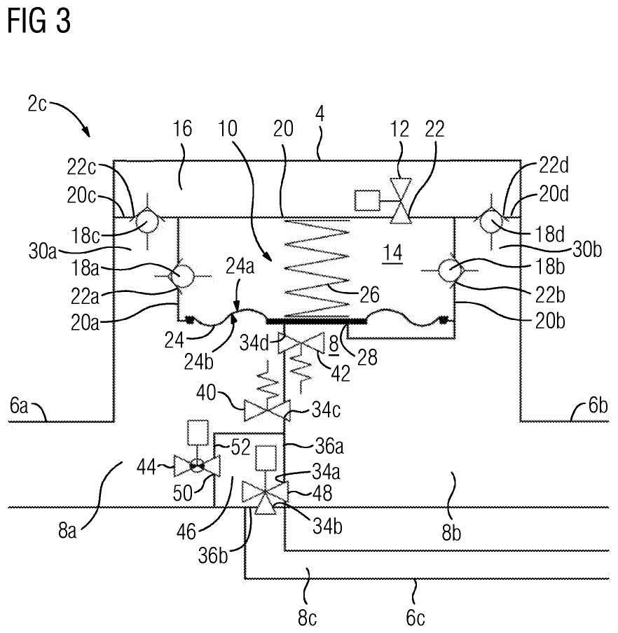

FIG. 3 shows a schematic view of a valve assembly 2c according to a fourth embodiment. The valve assembly 2c encompasses a bypass valve 44, which is fluidically connected to the tank connection 6a or the tank-side vent duct 8a, on the one hand, and to the filter connection 6b or the filter-side vent duct 8b as well as to the filling pipe connection 6c or the filling pipe-side vent duct 8c, on the other hand. So this can be accomplished, the bypass valve 44 leads initially into a collecting space 46. In the collecting space 46, a switch valve 48 is arranged that depending on how it is controlled allows a fluid to flow into the filter-side vent duct 8b or the filling pipe-side vent duct 8c. The bypass valve 44 is designed here as control valve with actuator, for example as SMA valve. The bypass valve 44 is arranged in an opening 50 of an inner wall 52 of the housing 4 separating the tank-side vent duct 8a from the collecting space 46, the switch valve 48 both in an opening 34a of the inner wall 36a and in an opening 34b of the inner wall 36b. The collecting space 46 offers the advantage that only the bypass valve 44 connected upstream has a control characteristic and the switch valve 48 acts as pure 3/2-way valve so that only the bypass valve 44 is able to execute intermediate settings of the actuator. Apart from that, reference is made to the explanations given above for FIG. 1 and FIG. 2 with regard to both design and function.

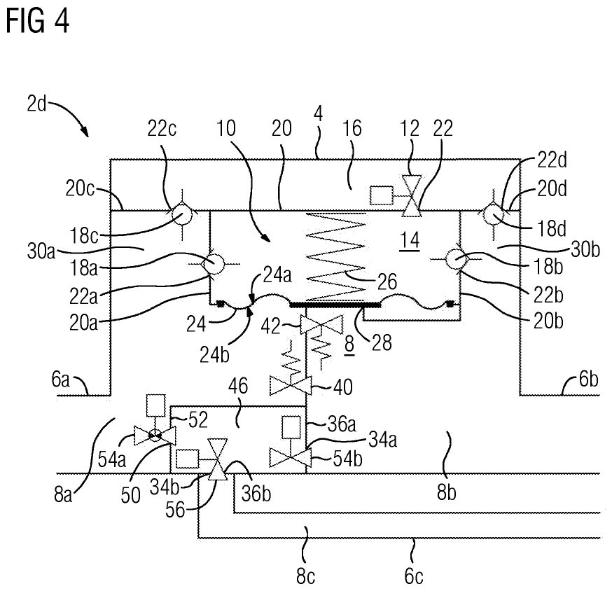

FIG. 4 shows a schematic view of a valve assembly 2d according to a fifth embodiment. The valve assembly 2d encompasses a first bypass valve 54a, which is fluidically connected to the tank connection 6a or the tank-side vent duct 8a, on the one hand, and to the collecting space 46, on the other hand. A second bypass valve 54b leads from the collecting space 46 into the filter-side vent duct 8b. Furthermore, a recirculation valve 56 leads from the collecting space 46 into the filling pipe-side vent duct 8c. The bypass valve 54a is designed as control valve with actuator, for example as SMA valve. Both the bypass valve 54b and the recirculation valve 56 are open/close valves that can likewise have SMA actuators, for example. The first bypass valve 54a is arranged in an opening 50 of an inner wall 52 of the housing 4 separating the tank-side vent duct 8a from the collecting space 46, the second bypass valve 54b is arranged in an opening 34a of an inner wall 36a of the housing 4 separating the collecting space 46 from the filter-side vent duct 8b and the recirculation valve 56 is arranged in an opening 34b of an inner wall 36b of the housing 4 separating the collecting space 46 from the filling pipe-side vent duct 8c. Apart from that, reference is made to the explanations given for FIG. 1A, FIG. 1B, FIG. 2 and FIG. 3 with regard to both design and function.

### LIST OF REFERENCE NUMERALS

2a, 2b, 2c, 2d Valve assembly
4 Housing
4a Intermediate housing
4b Housing lid
4c Housing bottom
6a Tank connection
6b Filter connection
6c Filling pipe connection
8 Vent duct
8a Tank-side vent duct
8b Filter-side vent duct
8c Filling pipe-side vent duct
10 Main vent valve
12 Pilot valve
14 Pressure chamber
16 Overflow area
18a Tank-pressure chamber-check valve
18b Filter-pressure chamber-check valve
18c Overflow area-tank-check valve
18d Overflow area-filter-check valve
20, 20a, 20b, 20c, 20d Inner wall
22, 22a, 22b, 22c, 22d Opening
24 Valve membrane
24a Pressure side
24b Flow side
26 Pre-tensioning element
28 Opening of the vent duct
30a First fluid duct
30b Second fluid duct
32 Bypass valve
34a, 34b, 34c, 34d Opening
36a, 36b Inner wall
38 Recirculation valve
40 Excess pressure protection valve
42 Negative pressure protection valve
44 Bypass valve
46 Collecting space
48 Switch valve
50 Opening
52 Inner wall
54a, 54b Bypass valve
56 Recirculation valve

1. A valve assembly for a fuel tank, comprising:
a) a housing;
a1) with a tank connection to connect the valve assembly to the fuel tank; and
a2) with a filter connection to connect the valve assembly to an active carbon filter;
b) a vent duct, wherein the tank connection and the filter connection are or can be fluidically connected through the vent duct, and wherein a main vent valve with a valve element is arranged in the vent duct, the valve element closing the vent duct in a closing position and opening the vent duct in a releasing position;
c) a pilot valve to open the main vent valve, wherein the pilot valve is or can be fluidically connected to a pressure chamber of the main vent valve, on the one hand, and to an overflow area, on the other hand, wherein the overflow area fluidically connects or can fluidically connect the tank connection or a tank-side vent duct and the filter connection or a filter-side vent duct; and
d) at least three check valves, wherein:
d1) a tank-pressure chamber-check valve is or can be fluidically connected to the tank connection or the tank-side vent duct, on the one hand, and to the pressure chamber of the main vent valve, on the other hand;
d2) an overflow area-rank-check valve is or can be fluidically connected to the overflow area, on the one hand, and to the tank connection or the tank-side vent duct, on the other hand; and
d3) an overflow area-filter-check valve is or can be fluidically connected to the overflow area, on the one hand, and to the filter connection or the filter-side vent duct, on the other hand.

2. The valve assembly according to claim 1, further including a pressure chamber-filter-check valve, which is or can be fluidically connected to the pressure chamber of the main vent valve, on the one hand, and to the filter connection or the filter-side vent duct, on the other hand.

3. The valve assembly according to claim 1, further including a housing with a filling pipe connection to connect the valve assembly to a filling pipe of the fuel tank.

4. The valve assembly according to claim 1, wherein the valve element of the main vent valve is configured as a valve membrane, wherein
the valve membrane has a pressure side facing the pressure chamber of the main vent valve and a flow side facing the tank connection or the tank-side vent duct, the filter connection or filter-side vent duct; and wherein
the flow side of the valve membrane closes the vent duct in the closing position of the valve element and opens the vent duct in the releasing position of the valve element; and wherein
a pre-tensioning element arranged in the pressure chamber of the main vent valve exerts a force on the pressure side of the valve membrane.

5. The valve assembly according to claim 1, further including at least one bypass valve, which is or can be fluidically connected to the tank connection or the tank-side vent duct, on the one hand, and to the filter connection or the filter-side vent duct, on the other hand.

6. The valve assembly according to claim 3, further including at least one recirculation valve, which is or can be fluidically connected to the tank connection or the tank-side vent duct, on the one hand, and to the filling pipe connection or the filling pipe-side vent duct, on the other hand.

7. The valve assembly according to claim 1, further including at least one excess pressure protection valve, which is or can be fluidically connected to the tank connection or the tank-side vent duct, on the one hand, and to the filter connection or the filter-side vent duct, on the other hand.

8. The valve assembly according to claim 1, further including at least one negative pressure protection valve, which is or can be fluidically connected to the tank connection or the tank-side vent duct, on the one hand, and to the filter connection or the filter-side vent duct, on the other hand.

9. The valve assembly according to claim 1, wherein the housing forms an inner wall or several inner walls, which separate the pressure chamber, the overflow area, the tank-side vent duct and/or the filter-side vent duct from one another, and wherein the pilot valve, the tank-pressure chamber-check valve, the overflow area-tank-check valve and/or the overflow area filter check valve, are in each case arranged in an opening formed in the inner wall or inner walls.

10. The valve assembly according to claim 2, wherein the housing forms an inner wall or several inner walls that separate the pressure chamber, the overflow area, the tank-side vent duct and/or the filter-side vent duct from one another, and wherein the pressure chamber-filter-check valve is arranged in an opening formed in the inner wall or the inner walls.

11. The valve assembly according to claim 5, wherein the housing forms an inner wall or several inner walls that separate the pressure chamber, the overflow area, the tank-side vent duct, the filter-side vent duct and/or the filling pipe-side vent duct from one another, and wherein the at least one bypass valve is arranged in an opening formed in the inner wall or inner walls.

12. The valve assembly according to claim 6, wherein the housing forms an inner wall or several inner walls that separate the pressure chamber, the overflow area, the tank-side vent duct, the filter-side vent duct and/or the filling pipe-side vent duct from one another, and wherein the at least one recirculation valve is arranged in an opening formed in the inner wall or the inner walls.

13. The valve assembly according to claim 7, wherein the housing forms an inner wall or several inner walls that separate the pressure chamber, the overflow area, the tank-side vent duct, the filter-side vent duct and/or the filling pipe-side vent duct from one another, and wherein the excess pressure protection valve is arranged in an opening formed in the inner wall or the inner wall.

14. The valve assembly according to claim 9, wherein the housing forms an inner wall or several inner walls that separate the pressure chamber, the overflow area, the tank-side vent duct, the filter-side vent duct and/or the filling pipe-side vent duct from one another, and wherein the negative pressure protection valve is arranged in an opening formed in the inner wall or the inner walls.

15. The valve assembly according to claim 1, wherein the pilot valve is an SMA valve or an EAP valve or a solenoid valve or a pneumatic valve.

16. The valve assembly according to claim 5, wherein the at least one bypass valve is an SMA valve or an EAP valve or a solenoid valve or a pneumatic valve.

17. The valve assembly according to claim 6, wherein the at least one recirculation valve is an SMA valve or an EAP valve or a solenoid valve or a pneumatic valve.

18. The valve assembly according to claim 1, wherein the valve assembly is configured for the controlled and/or managed and/or regulated output or input of a fluid from or into the fuel tank.

19. The valve assembly according to claim 18, wherein the valve assembly is configured for the controlled and/or managed and/or regulated output or input of gas or air or air enriched or saturated with hydrocarbons from or into the fuel tank.
